(19) United States
(12) Patent Application Publication
(10) Pub. No.: US 2009/0141746 A1
(43) Pub. Date: Jun. 4, 2009

(54) SOLID-STATE LASER DEVICE

(75) Inventors: Shuichi Fujikawa, Chiyoda-ku (JP); Junji Kano, Chiyoda-ku (JP); Kazuki Kuba, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/916,114

(22) PCT Filed: May 19, 2006
(86) PCT No.: PCT/JP2006/310040

§ 371 Date: Sep. 3, 2008

(30) Foreign Application Priority Data
Jun. 2, 2005 (JP) 2005-162607

(51) Int. Cl. H01S 3/11; H01S 3/00; H01S 3/10

(52) U.S. Cl. 372/10; 372/33; 372/21

(57) ABSTRACT

In a solid-state laser device, a single outer casing (1) having an approximately sealed structure is included; a single or a plurality of inner casings (2) are provided inside the outer casing (1); in some or all of the inner casings (2), an air cleaning unit (4) is included in which the air within the outer casing (1) is made clean and supplied into the inner casings (2); inside the outer casing (1), there disposed are a laser light-source (5, 6, 7) having a solid-state laser medium (501) and a light resonator, and an optical system (10, 11, 901) that transmits or interrupts a laser beam (8) emitted from the laser light-source; in addition, the laser light-source (5, 6, 7) and the optical system (10, 11, 901) or part of them are contained inside the inner casings (2); thus, in a simple, compact and inexpensive configuration, it is possible to prevent degradation of optical components and dew condensation thereon, and to stably supply a laser beam.

### TECHNICAL FIELD

The present invention relates to solid-state laser devices that achieve high reliability thereof.

### BACKGROUND ART

As for a solid-state laser device, optical components mounted in a light path thereof are contaminated by ingress of dust from outside of the light path, so that the transmissivity of a laser beam is reduced, which has caused a problem. In addition, dust that adheres onto surfaces of the optical components scatters a laser beam that passes through the optical components, so that a light-condensing capability of the laser beam is reduced, which has caused a problem. In addition, adhered substance on the surfaces of the optical components absorbs a laser beam, resulting in not only destroying coating provided on the surfaces of the optical components, but also damaging host material of the optical components, which has caused a problem.

To this end, in a conventional solid-state laser machining apparatus, the above problems have been solved in such a manner that, in order to remove dust, optical elements are placed within a sealed container; a gas cleaner is provided inside the container; and the gas within the container is made clean (for example, Patent Document 1). In addition, part of an optical system is enclosed by a cover; and, by applying pressure within the cover by cleaned gas that is guided thereinto via a dust filter from the exterior, adhesion of dust onto the optical system has been prevented (for example, Patent Document 2).

[Patent Document 1] Japanese Patent Application Publication No. H05-7043 (Paragraphs 0013 through 0017, FIG. 1).

[Patent Document 2] Japanese Patent Application Publication No. H08-332586 (Paragraph 0028, FIG. 1).

### DISCLOSURE OF THE INVENTION

### Problems to be Solved by the Invention

In order to prevent the ingress of dust into a laser's light-path, as set forth in Patent Document 1, it is preferable to place an optical system within a completely sealed container. However, in order to provide a completely sealed structure, it becomes necessary not only to provide a sealing means such as an O-ring, but also to enclose the surroundings of the optical components by a tight box-type structure; therefore, the structure becomes complex, so that maintainability is reduced, and manufacturing costs are increased, which have caused a problems.

However, as set forth in Patent Document 1, when a small-size laser device has an optical system in which the number of optical elements is small, a small container can be used for containing the optical system, so that it is possible to completely seal the container within which the optical system is placed. On the other hand, in such a large-size laser device whose output exceeds, for example, 1 kW, the number of optical elements becomes large, and an optical system tends to be upsized; thus, it becomes necessary to upsize the container that contains the optical system or to provide a plurality of containers, so that it has been difficult to achieve completely sealing the container within which the optical system is placed. In addition, because of increase in the optical elements, electric wiring and a cooling-pipe arrangement required to drive the optical elements and to provide cooling therefor become large; many holes for the wiring into the container or those for the piping are required, which becomes factors responsible for a reduction in a level of the container's sealing, so that it has been practically impossible to completely seal the container that contains the optical system.

For those reasons, as for a laser device that is difficult to completely seal the container within which an optical system is contained, a dust-tight structure has been adopted in which the optical system is enclosed by covers each of which is approximately sealed, and ducts allow the covers to communicate with one another so that a laser beam is passed through within the ducts; however, dust-tight effects cannot have been sufficiently obtained. To this end, it is a general practice to apply a method to install the laser device in an environment such as a clean room where a cleanliness level of external atmospheric gas is controlled, and to have the influence of dust refrained in a state close to a complete sealing; thus, a clean room or the like is required for the installation of the laser device, so that there have been problems with increases in costs and of an installation area, and with limitations of installation places.

In addition, as set forth in Patent Document 2, in a case in which the inside of a container is kept at a positive pressure by making the external atmosphere clean and sending it into the container that contains an optical system, it is not necessary to completely seal the container; thus, it becomes possible to apply the case to a large-size laser device. However, because the external air is directly made clean and sent into the container, unless installing the device in such a clean room, clog of cleaning dust-filters occurs in a short time, resulting in a reduction in productivity owing to a replacement of expendable components and an increase of running costs, which has been a problem.

Moreover, in a conventional laser device, humidity in the ambient atmosphere of an optical system is not controlled, so that dew condensation occurs on the optical components due to the increase in ambient temperature of the laser device; thus, there have been problems in which coating on the surfaces of the optical components degrades, and at the same time a light-condensing capability of a laser beam that passes through the optical components on which the dew condensation has occurred is reduced.

The present invention has been directed at solving those problems, and an object is to provide a highly reliable solid-state laser device in a simple, compact and inexpensive configuration that is capable of preventing degradation of optical components and dew condensation thereon, and of stably supplying a laser beam.

### Means for Solving the Problems

In one aspect of the present invention, a solid-state laser device comprises: a laser light-source having a solid-state laser medium and a light resonator; an optical system for transmitting or interrupting a laser beam emitted from the laser light-source; an outer casing having an approximately sealed structure, for placing thereinside the laser light-source and the optical system; a single or a plurality of inner casings provided inside the outer casing, for placing thereinside the laser light-source, and the optical system or part of the optical system; and at least one clean-air supplying means for making clean the air within the outer casing, for supplying the cleaned air into the inner casings each, and for keeping gaseous pressure within the inner casings each higher than gaseous pressure within the outer casing.

### EFFECTS OF THE INVENTION

According to the present invention, as explained above, it is possible to always maintain the surrounding atmosphere of an optical system that transmits or shuts a laser beam in a clean state; therefore, without installing the device in an environment such as a clean room where a cleanliness level of external atmospheric gas is controlled, there exist effects to prevent degradation of optical components and damage to the optical components owing to adhesion of foreign substance, and to be able to enhance reliability of a solid-state laser device.

### BRIEF DESCRIPTION OF DRAWINGS

FIG. 1 is a schematic diagram illustrating a configuration of a solid-state laser device in Embodiment 1 of the present invention;

FIG. 2 is a schematic diagram illustrating a configuration of a solid-state laser device in Embodiment 2 of the present invention;

FIG. 3 is a schematic diagram illustrating a configuration of a solid-state laser device in Embodiment 3 of the present invention; and

FIG. 4 is a schematic diagram illustrating a configuration of a solid-state laser device in Embodiment 4 of the present invention.

### BEST MODE FOR CARRYING OUT THE INVENTION

### Embodiment 1

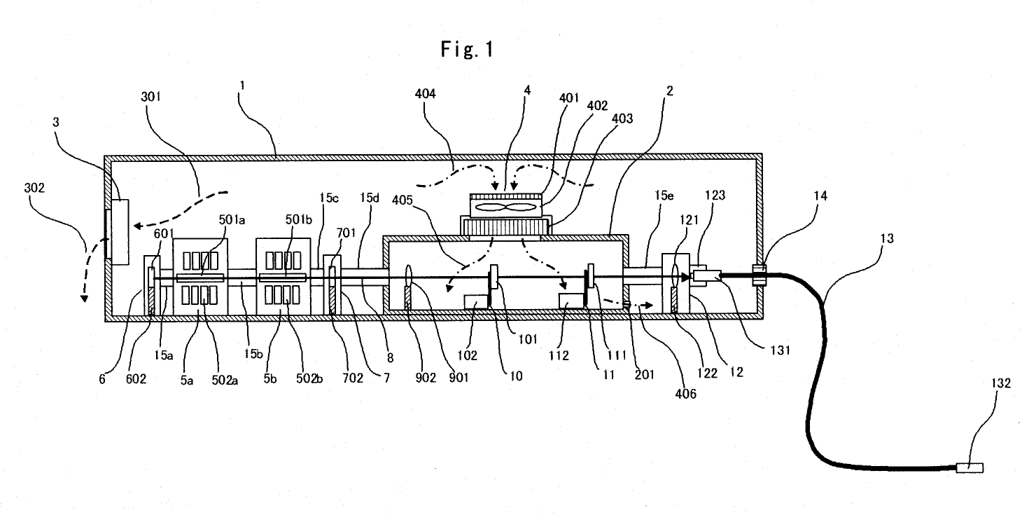

FIG. 1 is a schematic diagram illustrating a configuration of a solid-state laser device in Embodiment 1 of the present invention. In FIG. 1, “1” designates an outer casing that has an approximately sealed structure, which also serves as a protection enclosure so as to prevent leakage of a laser beam and scattered light to the exterior. Here, the approximately sealed structure means that, according to the International Protection code of foreign-substance ingress specified based on IEC International Standard 529, the structure has the sealing property in IP 21 through IP 56 or that equivalent to these IP codes (hereinafter in a similar fashion). “2” designates an inner casing that is disposed in the interior of or inside the outer casing 1. “3” designates a dehumidifier that is a dehumidifying means mounted on a side wall of the outer casing 1 so that water moisture within the outer casing 1 is released outside the outer casing 1. “301” and “302” are the broken lines that schematically denote the moisture 301 within the outer casing 1, and the moisture 302 that is released outside the outer casing 1. Note that, in this embodiment, for the dehumidifier 3, an “SP-dehumidifier ROSAHL” manufactured by Ryosai Technica Co., Ltd. is used, which utilizes a solid-polymer electrolyte film and electrolyzes thereby the moisture 301 within the outer casing 1. “4” designates an air cleaning unit that is a clean-air supplying means disposed on a top-panel portion of the inner casing 2; i.e., the unit is constituted of a pre-filter 401 that preliminarily remove dust having particle diameters of several tens through several hundreds microns; a fan 402 that guides the air within the outer casing 1 into the inner casing 2; and a main filter 403 that removes dust having particle diameters down to ten microns or less. In this embodiment, glass wool is used for the pre-filter 401; in addition, for the main filter 403, a HEPA (high-efficiency particle air filter) filter is used, which can trap 99.97% or more of particles having a particle diameter of 0.3 micron. “404” denotes the air within the outer casing 1; “405” denotes the air that is guided into the inner casing 2 via the air cleaning unit 4; and “406” denotes the air that is exhausted into the outer casing 1 through an exhaust port 201 of the inner casing 2, all of which are indicated by the alternate long and short dashed lines. Here, without particularly providing the exhaust port 201, it may be possible to use such a gap as associated with wiring and/or piping into the inner casing 2.

“5a” and “5b” designate cavity units; within the cavity units 6a and 5b that are approximately sealed by covers, there disposed are rod-type solid-state laser media 501a and 501b, and semiconductor lasers 502a and 502b that are pumping light-sources to optically pump the rod-type solid-state laser media 501a and 501b, respectively. Note that, in this embodiment, for the rod-type solid-state laser media 501a and 501b, a YAG (yttrium aluminum garnet) crystal is used in which Nd (neodymium) is doped as an active material; it is possible to obtain a laser output of some 500 W from each of the cavity units 501a and 501b. In addition, although it is not shown in FIG. 1 that, in the actual cavity units 5a and 5b, there provided are a means for fixing the rod-type solid-state laser media 501a and 501b, a means for cooling the semiconductor lasers 502a and 502b, and the like. “6” designates a TR (total reflector) unit; within an approximately sealed cover, there disposed are a totally reflecting mirror 601, and a totally reflecting mirror holder 602 that holds the totally reflecting mirror 601, and provides an angle adjustment mechanism for the totally reflecting mirror 601. “7” designates a PR (partial reflector) unit; in the same manner of the TR unit 6, within an approximately sealed cover, there disposed are a partially reflecting mirror 701, and a totally reflecting mirror holder 702 that holds the partially reflecting mirror 701, and provides an angle adjustment mechanism for the partially reflecting mirror 701. Note that, the totally reflecting mirror 601 and the partially reflecting mirror 701 constitute a light resonator, so that a laser beam 8 is generated by the rod-type solid-state laser media 501a and 501b that are optically pumped by the semiconductor lasers 502a and 502b.

“901” designates a collimation lens that is disposed inside the inner casing 2, and collimates the laser beam 8 therewithin. “902” designates a collimation-lens holder that holds the collimation lens 901, and provides an adjustment mechanism for the collimation lens 901 in the vertical and horizontal directions. “10” designates a process shutter unit that is disposed inside the inner casing 2; via a servomotor 102, the unit interposes or retracts a process shutter mirror 101 into or out of an optical axis of the laser beam 8, so that emission and interruption of the laser beam 8 is controlled. “11” designates a safety shutter unit that is disposed inside the inner casing 2; during laser operations, a safety shutter mirror 111 is retracted from an optical axis of the laser beam 8 via a servomotor 112, and during laser halts, the safety shutter mirror 111 is interposed into the optical axis of the laser beam 8, so that the laser beam 8 is securely prevented from emitting to the exterior.

“12” designates a fiber introduction unit within an approximately sealed cover, there disposed are a coupling lens 121, and a coupling-lens holder 122 that holds the coupling lens 121 and provides an adjustment mechanism for the coupling lens 121 in the vertical, horizontal and optical axis directions. “13” designates an optical fiber that transmits a laser beam; “131” designates an incident-side fiber connector that is disposed on the laser beam's incident-side of the optical fiber 13; and “132” designates an emission-side fiber connector that is disposed on the laser beam's emission-side of the optical fiber 13. The incident-side fiber connector 131 is firmly fixed to the fiber introduction unit 12 via a receptacle 123 that is disposed on the fiber introduction unit 12. The laser beam 8 collimated by the collimation lens 901 is condensed by the coupling lens 121, and guided into the optical fiber 13. Note that, in an opening portion provided to take out the optical fiber 13 outside the outer casing 1, a gasket 14 made of polyurethane rubber is used, so that the sealing property is maintained. “15a,” “15b,” “15c,” “15d,” and “15e” are beam ducts that are provided between respective units so that the laser beam 8 and scattered light are prevented from leaking; although it is not shown in the figure that, at connecting portions with each of the units, O-rings made of silicon rubber are used, so that the sealing property is maintained.

According to this embodiment, the inner casing 2 is provided inside the outer casing 1 having an approximately sealed structure, and the air within the outer casing 1 is made clean and supplied into the inner casing 2 via the air cleaning unit 4, so that gaseous pressure within the inner casing 2 is kept higher than gaseous pressure within the outer casing 1; therefore, without installing the device in the environment such as a clean room where a cleanliness level of external atmospheric gas is controlled, it is not only possible to prevent ingress of foreign substance such as dust into the inner casing 2, but also possible to always maintain in a clean state the surrounding atmosphere of the optical components mounted inside the inner casing 2. In addition, even when outgases are produced within the inner casing 2, they are exhausted, together with the clean air, through the exhaust port 201; therefore, even in a case in which a high-powered laser beam exceeding 1 kW is transmitted or reflected by the optical components mounted inside the inner casing 2, it is possible to effectively prevent degradation of the optical components and damage thereto, and to achieve a long operating life. In addition, because the cycle of cleaning that is regularly performed for the optical components can be extended, it is possible to shorten downtime required for a maintenance of the device; in addition, it is possible to lower running costs. Moreover, in this embodiment, because the PR unit 7 and the fiber introduction unit 12 are allowed to communicate with one another via the beam ducts 15d and 15e each of which has a sealed structure, the PR unit 7 and the fiber introduction unit 12 are always filled with clean air therewithin; therefore, it is possible to obtain effects similar to the case of being placed within the inner casing 2.

In addition, according to this embodiment, a configuration is adopted in which the air within the outer casing 1 having an approximately sealed structure is circulated via the air cleaning unit 4; therefore, even when the device is installed in the environment where the amount of dust is not controlled, it is possible to prevent the filters in the air cleaning unit 4 from clogging in a short time, and to curb a reduction in productivity and an increase of running costs owing to a replacement of expendable components. In addition, even when the outer casing 1 and the inner casing 2 are opened for a maintenance or the like, a level of air cleanliness therein can be recovered in a short time; therefore, it is possible to further shorten downtime required for the maintenance.

In addition, according to this embodiment, a configuration is adopted in which an opening is provided in the side wall of the outer casing 1, and the dehumidifier 3 is provided; then, moisture contained in the air of the outer casing 1 is released outside the outer casing 1; therefore, even when the device is installed in the environment where temperature and humidity are not controlled, a relative humidity within the outer casing 1 is always maintained at a preset value or less; thus, it is possible to prevent dew condensation from forming on the optical components, and also to always supply a stable laser beam without depending on the surrounding environment.

Note that, according to this embodiment, a configuration is adopted in which there disposed are, inside the single outer casing 1 also serving as a protection casing, both a laser light-source including the cavity units 5a and 5b, the TR unit 6 and the PR unit 7, and also an optical system provided to couple the laser beam 8 emitted from the laser light-source with the optical fiber 13; in addition, the inner casing 2 is provided inside the outer casing 1, and the optical system is disposed inside the inner casing 2; therefore, in the simple and compact configuration, it is possible to effectively improve a level of air cleanliness of the surroundings of the optical components, and to achieve a long operating life of the optical components. Furthermore, even when vibrations and mechanical disturbances occur, an optical axis of the laser light-source and an optical axis of the optical system do not become misaligned; therefore, it becomes possible to prevent damage at the incident end-face of the optical fiber 13 owing to deviation of the optical axes, to perform fiber transmission of a laser beam that is excellent in reliability, and to supply the stable laser beam.

### Embodiment 2

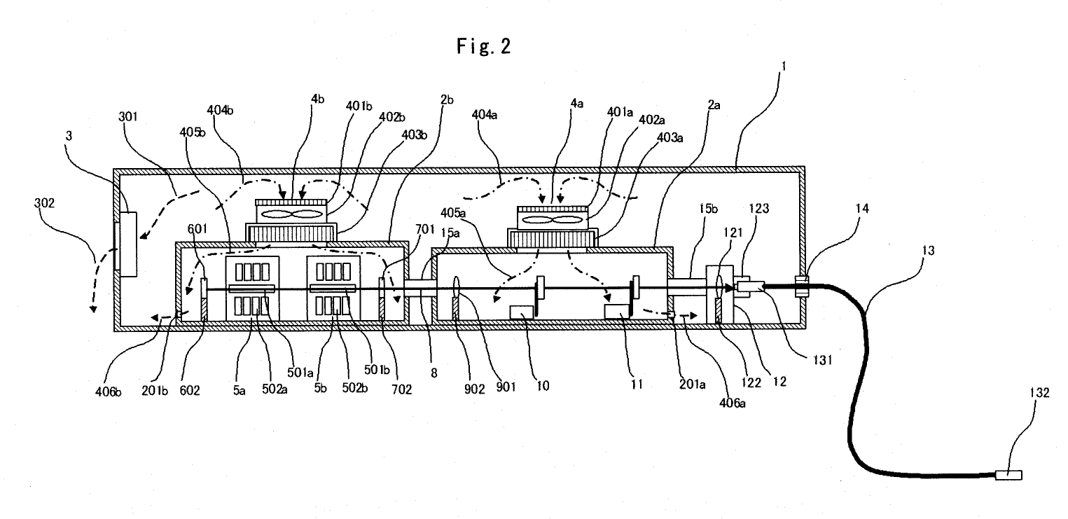

FIG. 2 is a schematic diagram illustrating a configuration of a solid-state laser device in Embodiment 2 of the present invention. In this embodiment, two of such inner casings 2a and 2b are provided inside a single such outer casing 1 having an approximately sealed structure. Inside the first inner casing 2a, in the same manner as Embodiment 1, the collimation lens 901, the process shutter unit 10, and the safety shutter unit 11 are disposed. In addition, inside the second inner casing 2b, there disposed is a laser light-source that is constituted of two of such cavity units 5a and 5b, the totally reflecting mirror 601, and the partially reflecting mirror 701.

As described in this embodiment, even when a configuration is adopted in which a plurality of such inner casings 2a and 2b are provided inside the single outer casing 1, it is not only possible to obtain effects similar to Embodiment 1, but also possible, by disposing the cavity units 5a and 5b inside the inner casing 2b, to mitigate the requirement for the sealing property of the cavity units 5a and 5b on a unit basis; moreover, it is possible to always maintain in a clean state the surroundings of light emitting portions of such semiconductor lasers 501a and 501b used as a pumping light-source; therefore, it is possible to effectively prevent degradation of the semiconductor lasers 501a and 501b, and to achieve a long operating life. Moreover, because it is not necessary to seal the light path between the totally reflecting mirror 601, the cavity units 5a and 5b, and the partially reflecting mirror 701 via beam ducts, there also exists an effect in which it becomes easy to perform assembly of a laser light-source, and maintenance and adjustment thereof.

Note that, in this embodiment, a configuration is adopted in which such air cleaning units 4a and 4b are mounted for the first and second inner casings 2a and 2b, respectively; however, the first inner casing 2a and the second inner casing 2b are allowed to communicate with each other via such beam duct 15a; therefore, even when such air cleaning unit 4 is mounted only at either the first inner casing 2a or the second inner casing 2b, a level of air cleanliness within such inner casings 4 can be maintained; therefore, it is possible to not only obtain effects similar to this embodiment, but also reduce the number of such air cleaning units 4; thus, it is possible to lower the costs for manufacturing, assembling, and running.

On the other hand, similarly to this embodiment, when a configuration is adopted in which a plurality of such air cleaning units 4 is mounted for a plurality of such inner casings 2, even when either the function of an arbitrary air cleaning unit 4 is reduced owing to clog of the filters or the function thereof is stopped by a failure, a level of air cleanliness within each of the inner casings 2 can be maintained, so that it is possible to reduce risks of failure of the air cleaning units 4. In addition, in a case in which the inner casings 2 are opened to external atmosphere for a maintenance thereof or the like, it is possible to recover a level of cleanliness in a short time at a time of restoration; therefore, there exists an effect in which it is possible to shorten downtime associated with the maintenance.

Note that, when a configuration is adopted in which a plurality of such air cleaning units 4 is mounted for a single such inner casing 2, it is needless to say that there exist effects to reduce risks of failure of the air cleaning units 4, and to shorten recovery time of a level of cleanliness in a case afterward opened to external atmosphere.

### Embodiment 3

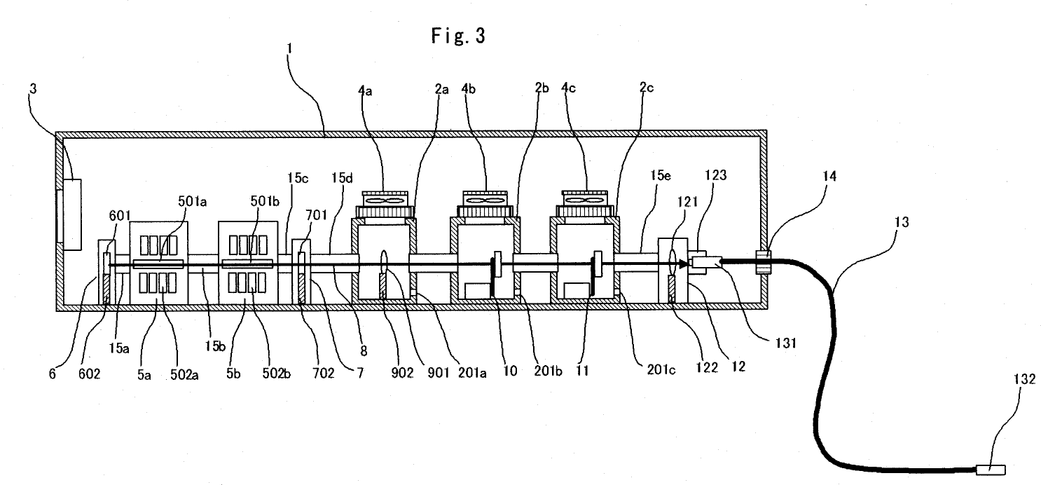

FIG. 3 is a schematic diagram illustrating a configuration of a solid-state laser device in Embodiment 3 of the present invention. In this embodiment, such inner casings 2a, 2b, and 2c are individually mounted for the collimation lens 901, the process shutter unit 10, and the safety shutter unit 11, which are the units constituting part of an optical system that transmits such laser beam 8 into the optical fiber 13. According to this embodiment, it is also possible to obtain effects similar to Embodiment 1 and Embodiment 2; moreover, because the inner casings 2a, 2b, and 2c are individually provided for the units each, it is only required to open the inner casing 2 of a unit that is to be maintained when a maintenance work is carried out for each unit; therefore, it is possible to effectively reduce risks of ingress of dust or the like into each inner casing 2 for the rest of the units, and to further increase reliability.

Note that, in this embodiment, a structure is described in which the collimation lens 901, the process shutter unit 10, and the safety shutter unit 11 are individually contained inside the inner casings 2a, 2b, and 2c, respectively; however, the units mounted within such inner casings 2 are not limited to those. For example, in a configuration in which the laser beam 8 is coupled with a plurality of such optical fibers 13, a unit for dividing the laser beam 8 into a plurality of light paths may be mounted within such inner casings 2.

It is essential that the units including the optical components that transmit or reflect the laser beam 8 are mounted inside such inner casing 2 that is mounted inside the outer casing 1, and the surroundings of the optical components are maintained in a clean state via an air cleaning unit or units; thus, it is possible to effectively prevent degradation of the optical components and damage thereto, and to obtain a solid-state laser device that has excellent reliability. The number of such inner casings 2 placed inside the outer casing 1, the number of the optical components and kinds thereof placed inside the inner casings each may be designed as appropriate according to an object such as a size and a structure, and a method for maintenance. For example, it may be possible to adopt a configuration in which both a laser light-source and an optical system are mounted within a single such inner casing 2.

### Embodiment 4

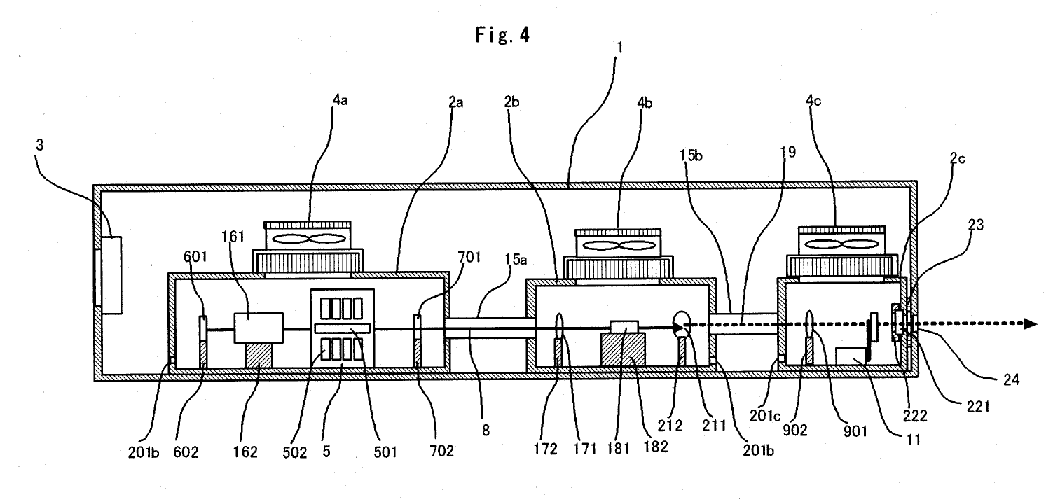

FIG. 4 is a schematic diagram illustrating a configuration of a solid-state laser device in Embodiment 4 of the present invention. Note that, in this embodiment, based on a wavelength conversion technology using a nonlinear optical crystal, the configuration is shown in which a second harmonic is generated. In FIG. 4, “161” designates an acousto-optical element that is disposed, in such first inner casing 2a, between a rod-type solid-state laser medium 501 and the totally reflecting mirror 601; by giving modulation to resonator's losses in a constant period, Q-switching pulse oscillation is performed. “162” designates an acousto-optical element holder that holds the acousto-optical element 161, and provides an angle adjustment mechanism for the acousto-optical element 161. Also in this embodiment, for the rod-type solid-state laser medium 501, a YAG (yttrium aluminum garnet) crystal is used in which Nd (neodymium) is doped; from a laser light-source mounted inside the first inner casing 2a, fundamental pulse light 8 is emitted, which has a wavelength of 1064 nm (nanometer) and a pulse width of some 60 through 70 ns (nanosecond).

“171” designates a light-condensing lens that is mounted inside such second inner casing 2b, and condenses the fundamental pulse light 8; and “172” designates a light-condensing lens holder that not only holds the light-condensing lens 171, but also includes an adjustment mechanism for the light-condensing lens 171 in the vertical and horizontal directions. “181” designates the nonlinear optical crystal; in this embodiment, for generation of a second harmonic with respect to a wavelength of the fundamental's 1064 nm, an LBO (lithium triborate) crystal of a length of 15 mm is used in which phase matching conditions of type-2 can be obtained. “182” designates a nonlinear optical-crystal holder that holds the nonlinear optical crystal 181, and provides a temperature adjustment function for the nonlinear optical crystal 181. When such fundamental pulse light 8 condensed by the light-condensing lens 171 is made incident to the nonlinear optical crystal 181, part of the fundamental pulse light 8 is converted into a second harmonic 19 of a wavelength of 532 nm. “211” designates a separation mirror that is provided with two-wavelength coating where light of wavelength 1064 nm is reflected, and wavelength of wavelength 532 nm is transmitted; with respect to an optical axis of the second harmonic 19, the mirror is mounted at the incidence angle of 45 degrees. “212” designates a separation-mirror holder that holds the separation mirror 211. In the fundamental pulse light 8 that is made incident to the nonlinear optical crystal 181, part thereof is converted into the second harmonic 19, and the rest thereof is transmitted through the nonlinear optical crystal 181 while maintaining the wavelength of 1064 nm. Therefore, a laser beam emitted from the nonlinear optical crystal 181 is mixed with such fundamental pulse light 8 of wavelength 1064 nm and the second harmonic 19 of wavelength 532 nm. The laser beam mixed with the fundamental pulse light 8 and the second harmonic 19 is made incident to the separation mirror 211, so that the second harmonic 19 is only transmitted therethrough; thus, it is possible to split the fundamental pulse light 8 and the second harmonic 19 each other. The fundamental pulse light 8 made incident to the separation mirror 211 receives reflection-action by the separation mirror 211, resulting in the optical axis perpendicularly bent thereafter. Note that, part of the fundamental pulse light 8 having been reflected by the separation mirror 211 is absorbed by a damper, though not shown in the figure, which is disposed in the same manner inside the second inner casing 2b.

The second harmonic 19 having been split from the fundamental pulse light 8 by the separation mirror 211 is collimated by the collimation lens 901 that is mounted inside such third inner casing 2c, and is emitted to the exterior via an emitting window 221 and an emitting port 24 that is provided in a side wall of the outer casing 1. Note that, “222” designates an emitting-window holder that is provided for fixing the emitting window 221 on a side wall of the third inner casing 2c; although not shown in the figure, an O-ring made of fluoro-rubber is used to seal the emitting window 221 so as to keep the sealing property at a fixing portion thereof. “23” designates a ring-shaped gasket that is made of expandable PTFE (tetrafluoroethylene); thereby, the sealing property is maintained at the emitting port 24.

As described in this embodiment, in a case in which the laser light-source that performs Q-switching pulse oscillation is used, even when an average power output is relatively low, peak outputs of pulses of light are high, which leads to an increase in risks of degradation of the optical components owing to humidity, and of damage to the optical components owing to adhesion of foreign substance thereonto. As described in this embodiment, when a configuration is adopted in which the outer casing 1 having an approximately sealed structure is provided, and the relative humidity within the outer casing 1 is controlled at a predetermined value or less by using the dehumidifier 3; in addition, such inner casings 2 are provided inside the outer casing 1, and the optical components are disposed inside the inner casings 2, so that, by using such air cleaning units 4 that are mounted on a top-panel portion of each of the inner casings 2, the cleaned-up air is circulated therethrough; thus, it is possible to obtain effects similar to Embodiment 1 through Embodiment 3; moreover, even when a laser light-source is used that performs Q-switching pulse oscillation, it becomes possible to decrease risks of degradation of the optical components and of damage thereto, and to stably supply the Q-switching pulses of light with high-peak outputs with a high reliability.

In addition, the efficiency of wavelength conversion to the second harmonic 19 is approximately proportional to the square of the incident intensity of the fundamental with respect to the nonlinear optical crystal 181. Therefore, in order to obtain high efficiency of the wavelength conversion, it is necessary to reduce the fundamental pulse light 8 to a fine diameter by the light-condensing lens 171. For this reason, even when a small amount of foreign substance such as dust is adhered on the incident surface of the nonlinear optical crystal 181, the nonlinear optical crystal 181 is easily destroyed by irradiation of such fundamental pulse light 8 that is condensed. Moreover, an LBO crystal used as the nonlinear optical crystal 181 in this embodiment has hygroscopic property; therefore, when used in an environment where humidity is high, moisture in the air is absorbed thereby, and degradation such as discoloration is accelerated. According to this embodiment, it is possible to obtain effects similar to Embodiment 1 through Embodiment 3; moreover, because it becomes possible to maintain the surrounding atmosphere of the nonlinear optical crystal 181 by the air that is clean and humidity thereof is controlled, degradation of the nonlinear optical crystal 181 can be curbed; in addition, even when the fundamental pulse light 8 is condensed to a fine diameter and made incident to the nonlinear optical crystal 181, it is possible to prevent damage or destruction of the nonlinear optical crystal 181, and to efficiently perform the wavelength conversion while maintaining a high reliability.

In this embodiment, a structure is described in which an LBO crystal is used as the nonlinear optical crystal 181 that performs generating the second harmonic; however, kinds of the nonlinear optical crystal 181 are not necessarily limited to this. For example, in a case in which a KTP (potassium titanyl phosphate) crystal is used for the nonlinear optical crystal 181, although an absorption coefficient of the fundamental becomes large, a high nonlinear constant is obtained, so that, even when the fundamental is low in output, it is possible to obtain relatively high efficiency of wavelength conversion; in addition, in a case in which an LN (lithium niobate) crystal of periodically-poled type is used, it is possible to extend an interaction length (coherent length), so that, even when continuous oscillation of the fundamental is used, it is possible to efficiently perform wavelength conversion. It is essential that a suitable nonlinear optical crystal may be selected according to desired specifications and capabilities therefor.

In addition, in this embodiment, a structure is described in which the second harmonic is generated; however, kinds of wavelength conversion are not limited to this; i.e., in a structure in which higher order harmonics—a third harmonic, a fourth harmonic, or a fifth harmonic—are generated, by placing a nonlinear optical crystal inside such inner casing 2, it is possible to obtain effects similar to this embodiment. In addition, in cases not limited to the harmonics generation, but in a case of wavelength conversion by optical parametric oscillation or sum frequency mixing, it is needless to say that similar effects can be obtained. It is essential that the nonlinear optical crystal which performs the wavelength conversion is mounted inside the inner casing 2; thus, it is possible to obtain effects similar to this embodiment.

In addition, in this embodiment, a structure is described in which the Q-switching pulse oscillation is performed using the acousto-optical element 161; however, in a structure in which Q-switching pulse oscillation is performed using an electro-optical element, it is possible to obtain effects similar to this embodiment. In addition, as for a structure in which high-peak pulses are generated, the present invention may be applied for a mode-locked laser. For example, in a structure in which ultrashort pulses of light using a KLM (Kerr-lens mode-locking) technique are amplified by a CPA (chirped pulse amplification) method, such inner casings 2 each may be provided for an oscillator that is a laser light-source, a pulse expansion unit that extends a pulse width of a laser beam brought out from the oscillator, a regenerative amplification unit that amplifies the laser beam in which the pulse width thereof has been expanded, and a pulse compression unit that compresses the laser beam in which the pulse width thereof has been amplified; thus, by controlling a level of cleanliness within the inner casings 2 and humidity therewithin, it is possible to obtain effects similar to this embodiment.

Note that, in Embodiment 1 through Embodiment 4, the structures are described in each of which a semiconductor laser is used for a pumping light-source that optically pumps a rod-type solid-state laser medium; however, kinds of the pumping light-source are not necessarily limited to this; when a discharge lamp is used as a pumping light-source, it is also possible to obtain similar effects.

In addition, in Embodiment 1 through Embodiment 4, the structures are described in each of which, for a solid-state laser medium used for the laser light-source, a rod-type YAG (yttrium aluminum garnet) crystal is used in which Nd (neodymium) is doped; however, a host material, an active material, and a shape of the solid-state laser medium are not necessarily limited to this. For example, for the solid-state laser medium, an alumina single-crystal doped with Ti (titanium) or Cr (chromium) may be used; in addition, a slab-type YAG (yttrium aluminum garnet) crystal doped with Yb (ytterbium) may be used. In addition, it is possible to apply the present invention to a structure in which, for a laser light-source, a so-called semiconductor laser utilizing a semiconductor as the solid-state laser medium is used.

In addition, in Embodiment 1 through Embodiment 4, the structures are described in each of which a HEPA filter is used as a main filter for the air cleaning unit; however, kinds of the air cleaning unit are not limited to this. For example, for a main filter, an ULPA (ultra-low penetration air filter) filter may be used, so that it is possible to further increase a ratio of dust collection; in addition, in a case in which organic constituent material, ionic material, or the like is preferably removed, a chemical filter may be concurrently used. It is essential that, according to contaminants and dust that ought to be removed, an optimum method for air cleaning may be selected. In addition, in Embodiment 1 through Embodiment 4, the structures are described in each of which the air cleaning unit is mounted on a top-panel portion of the inner casing; however, a mounting location of the air cleaning unit for the inner casing is not necessarily limited to this; according to placements of a laser light-source and/or an optical system, they may be placed at optimum positions.

In addition, in Embodiment 1 through Embodiment 4, the structures are described in each of which a dehumidifier of a solid-polymer electrolyte-film method is used; however, a structure of the dehumidifier is not necessarily limited to this; for example, silica gel that is a drying agent may be mounted inside an outer casing, so that similar effects can be obtained. Moreover, an electric power source for driving the dehumidifier is not required; therefore, even when the device is stopped or during a failure of electric power, it is possible to maintain humidity within the outer casing at an approximately constant level.

In addition, when a detector is provided to monitor humidity within an outer casing and the amount of dust within an inner casing, and the humidity and the amount of the dust reach to predetermined values or more, an interlock mechanism or the like may be provided so as to stop the device; thereby, it is possible to further increase reliability of a solid-state laser device.

### INDUSTRIAL APPLICABILITY

A wavelength-conversion laser device in the present invention is suitable when a preparation of a clean room or the like is difficult for installing the laser device.

1. A solid-state laser device, comprising:
a laser light-source having a solid-state laser medium and a light resonator;
an optical system for transmitting or interrupting a laser beam emitted from said laser light-source;
an outer casing having an approximately sealed structure, for placing thereinside said laser light-source and said optical system;
a single or a plurality of inner casings provided inside said outer casing, for placing thereinside said laser light-source, and said optical system or part of said optical system;
at least one clean-air supplying means for making clean the air within said outer casing, for supplying the cleaned air into said inner casings each, and for keeping gaseous pressure within said inner casings each higher than gaseous pressure within said outer casing; and
a dehumidifying means for releasing moisture within said outer casing outside said outer casing.

2. The solid-state laser device as set forth in claim 1, wherein an exhaust port is provided for said inner casings each so that the cleaned air supplied from the clean-air supplying means into said inner casings each is exhausted into said outer casing.

3. The solid-state laser device as set forth in claim 1 or claim 2, wherein a duct allows to communicate with one another said inner casings and units having an approximately sealed structure and containing thereinside part of the optical system.

4. The solid-state laser device as set forth in claim 1 or claim 2, wherein a plurality of said inner casings is included, and a duct allows said inner casings to communicate with one another.

5. The solid-state laser device as set forth in claim 4, wherein the clean-air supplying means is only provided for part of said inner casings among the plurality of inner casings.

6. The solid-state laser device as set forth in claim 5, wherein a plurality of said clean-air supplying means is provided for one of said inner casings.

7. (canceled)

8. The solid-state laser device as set forth in claim 1, wherein a nonlinear optical crystal is placed inside at least one of said inner casings.

9. The solid-state laser device as set forth in claim 1, wherein a pumping light-source for optically pumping the solid-state laser medium is a semiconductor laser.

10. The solid-state laser device as set forth in claim 1, wherein the solid-state laser medium is a semiconductor.

11. The solid-state laser device as set forth in claim 1, wherein the laser light-source performs Q-switching pulse oscillation.

12. The solid-state laser device as set forth in claim 1, wherein the laser light-source performs mode-locked pulse oscillation.
